(19) United States
(12) Patent Application Publication
(10) Pub. No.: US 2026/0322524 A1
(43) Pub. Date: Oct. 15, 2026

(54) MACHINE LEARNING-BASED RADIO RECEIVER

(71) Applicant: Nokia Solutions and Networks Oy, Espoo (FI)

(72) Inventors: Nicolas Marc Julien AUSSEL, Espoo (FI); Janne Matti Juhani HUTTUNEN, Espoo (FI); Mikko Johannes HONKALA, Espoo (FI)

(21) Appl. No.: 19/484,068

(22) PCT Filed: May 15, 2023
(86) PCT No.: PCT/EP2023/062990

§ 371 Date: Nov. 13, 2025

(51) Int. Cl. H04L 1/00

(52) U.S. Cl. CPC H04L 1/0003

(57) ABSTRACT

A method for use in a radio receiver is disclosed. The radio receiver is configured with a postprocessing function selected based on the modulation scheme of an input signal among a plurality of postprocessing functions supported by the radio receiver, wherein the selected postprocessing function is trained for postprocessing of a signal modulated according to the modulation scheme. Probability information are generated for the input bits by generating an intermediate signal from at least the modulated radio signal and performing postprocessing on the intermediate signal to generate the probability information using the selected postprocessing function.

### TECHNICAL FIELD

Various example embodiments relate generally to a method for use by a machine learning-based radio receiver and a machine learning-based radio receiver.

### BACKGROUND

Machine learning (ML)-based receivers are a recent development, where some functions of the radio receiver are learned by a neural network (NN). This facilitates improved performance and higher flexibility, as the parameters of the functions are learned directly from the training data set.

A ML-based radio receiver may be adapted for MIMO transmission, including SIMO, SISO transmissions. In an example implementation, such a radio receiver is a Deep Learning Receiver, DeepRx, which is configured to implement and learn a complete frequency-domain receiver. A DeepRx is based on deep convolutional neural networks (CNNs). A DeepRx may achieve high performance in various 5G MIMO scenarios.

However for ML-based receivers, such as a DeepRx, excessive computation may be necessary for processing the input modulated radio signal.

### SUMMARY

The scope of protection is set out by the independent claims. The embodiments, examples and features, if any, described in this specification that do not fall under the scope of the protection are to be interpreted as examples useful for understanding the various embodiments or examples that fall under the scope of protection.

According to a first aspect, a method comprises: receiving a modulated radio signal including input bits, wherein the input bits are modulated in the input radio signal according to a modulation scheme in a plurality of modulation schemes supported by the radio receiver; configuring the radio receiver with a postprocessing function selected based on the modulation scheme among a plurality of postprocessing functions supported by the radio receiver, wherein each of the plurality of postprocessing functions is based on a postprocessing neural network, NN, and is trained for postprocessing of a signal modulated according to a respective modulation scheme in the plurality of modulation schemes, wherein the selected postprocessing function is trained for postprocessing of a signal modulated according to said modulation scheme; generating probability information for the input bits, wherein generating the probability information includes: generating an intermediate signal from at least the modulated radio signal; and performing postprocessing on the intermediate signal to generate the probability information using the selected postprocessing function.

Generating the intermediate signal may include: performing preprocessing based on reference signals using a preprocessing function based on a preprocessing NN common to the plurality of modulation schemes to generate a preprocessed signal; performing signal processing on the preprocessed signal and the modulated radio signal to generate the intermediate signal. The signal processing may include equalization.

The method may comprise: obtaining information indicative of the modulation scheme, the information including a modulation type and a modulation order, wherein the selecting is performed based on at least one of the modulation type and the modulation order.

The plurality of postprocessing functions may include a first postprocessing function that is based on a first postprocessing NN and is adapted for postprocessing of a signal modulated according to a first modulation scheme having a first modulation type and a first modulation order,

The plurality of postprocessing functions may include a second postprocessing function that is based on a second postprocessing NN and is adapted for postprocessing of a signal modulated according to the first modulation scheme having the first modulation type and a second modulation order smaller than the first modulation order,

The second postprocessing function may use less computation resources than the first postprocessing function.

The second postprocessing NN may have a reduced model size compared to the first postprocessing NN.

The first postprocessing NN may include a plurality of computation functions including convolutional layers, each convolutional layer using convolution filters and generating corresponding output channels.

The second postprocessing NN may correspond to a subpart of the plurality of convolutional filters and corresponding output channels of at least one convolutional layer of the first postprocessing NN and when the selected postprocessing function is the second postprocessing function, the computation functions of the first postprocessing NN that are not in said subpart are deactivated.

The method may comprise: training simultaneously the preprocessing NN and a first postprocessing NN associated with a first modulation scheme having the highest modulation order; training each postprocessing NN associated with another modulation scheme having a lower modulation order than the first modulation scheme by using the trained preprocessing NN.

Training the postprocessing NN associated with the another modulation scheme may include: reducing the size of the first postprocessing NN associated with the first modulation scheme to generate a reduced postprocessing NN; training the reduced postprocessing NN by using the trained preprocessing NN; computing a performance indicator for the reduced postprocessing NN; repeating the reducing, training and computing steps for the reduced postprocessing NN until a performance decrease criterion is met for the performance indicator; using the last reduced postprocessing NN as the postprocessing NN associated with the second modulation scheme.

Reducing the size of the concerned NN may include at least one of: reducing the number of convolutional layers of the concerned NN; reducing the number of convolutional filters of the concerned NN.

The method may comprise: training simultaneously the preprocessing NN and the postprocessing NNs.

According to another aspect, an apparatus comprises means for performing a method comprising: receiving a modulated radio signal including input bits, wherein the input bits are modulated in the input radio signal according to a modulation scheme in a plurality of modulation schemes supported by the radio receiver; configuring the radio receiver with a postprocessing function selected based on the modulation scheme among a plurality of postprocessing functions supported by the radio receiver, wherein each of the plurality of postprocessing functions is based on a postprocessing neural network, NN, and is trained for postprocessing of a signal modulated according to a respective modulation scheme in the plurality of modulation schemes, wherein the selected postprocessing function is trained for postprocessing of a signal modulated according to said modulation scheme; generating probability information for the input bits, wherein generating the probability information includes: generating an intermediate signal from at least the modulated radio signal; and performing postprocessing on the intermediate signal to generate the probability information using the selected postprocessing function.

The apparatus may comprise means for performing one or more or all steps of the method according to the first aspect. The means may include circuitry configured to perform one or more or all steps of a method according to the first aspect. The means may include at least one processor and at least one memory storing instructions that, when executed by the at least one processor, cause the apparatus to perform one or more or all steps of a method according to the first aspect.

According to another aspect, an apparatus comprises at least one processor and at least one memory storing instructions that, when executed by the at least one processor, cause the apparatus to perform: receiving a modulated radio signal including input bits, wherein the input bits are modulated in the input radio signal according to a modulation scheme in a plurality of modulation schemes supported by the radio receiver; configuring the radio receiver with a postprocessing function selected based on the modulation scheme among a plurality of postprocessing functions supported by the radio receiver, wherein each of the plurality of postprocessing functions is based on a postprocessing neural network, NN, and is trained for postprocessing of a signal modulated according to a respective modulation scheme in the plurality of modulation schemes, wherein the selected postprocessing function is trained for postprocessing of a signal modulated according to said modulation scheme; generating probability information for the input bits, wherein generating the probability information includes: generating an intermediate signal from at least the modulated radio signal; and performing postprocessing on the intermediate signal to generate the probability information using the selected postprocessing function.

The instructions, when executed by the at least one processor, may cause the apparatus to perform one or more or all steps of a method according to the first aspect.

According to another aspect, a computer program comprises instructions that, when executed by an apparatus, cause the apparatus to perform: receiving a modulated radio signal including input bits, wherein the input bits are modulated in the input radio signal according to a modulation scheme in a plurality of modulation schemes supported by the radio receiver; configuring the radio receiver with a postprocessing function selected based on the modulation scheme among a plurality of postprocessing functions supported by the radio receiver, wherein each of the plurality of postprocessing functions is based on a postprocessing neural network, NN, and is trained for postprocessing of a signal modulated according to a respective modulation scheme in the plurality of modulation schemes, wherein the selected postprocessing function is trained for postprocessing of a signal modulated according to said modulation scheme; generating probability information for the input bits, wherein generating the probability information includes: generating an intermediate signal from at least the modulated radio signal; and performing postprocessing on the intermediate signal to generate the probability information using the selected postprocessing function.

The instructions may cause the apparatus to perform one or more or all steps of a method according to the first aspect.

According to another aspect, a non-transitory computer readable medium comprises program instructions stored thereon for causing an apparatus to perform at least the following: receiving a modulated radio signal including input bits, wherein the input bits are modulated in the input radio signal according to a modulation scheme in a plurality of modulation schemes supported by the radio receiver; configuring the radio receiver with a postprocessing function selected based on the modulation scheme among a plurality of postprocessing functions supported by the radio receiver, wherein each of the plurality of postprocessing functions is based on a postprocessing neural network, NN, and is trained for postprocessing of a signal modulated according to a respective modulation scheme in the plurality of modulation schemes, wherein the selected postprocessing function is trained for postprocessing of a signal modulated according to said modulation scheme; generating probability information for the input bits, wherein generating the probability information includes: generating an intermediate signal from at least the modulated radio signal; and performing postprocessing on the intermediate signal to generate the probability information using the selected postprocessing function.

The program instructions may cause the apparatus to perform one or more or all steps of a method according to the first aspect.

### BRIEF DESCRIPTION OF THE DRAWINGS

Example embodiments will become more fully understood from the detailed description given herein below and the accompanying drawings, which are given by way of illustration only and thus are not limiting of this disclosure.

FIG. 1 represents a simplified schematic of a radio receiver according to an example.

FIG. 2A shows a simplified schematic of a radio receiver according to an example.

FIG. 2B shows a simplified schematic of a radio receiver according to an example.

FIG. 2C shows a simplified schematic of a radio receiver according to an example.

FIG. 3 shows components of a NN according to an example.

FIG. 4A represents a simplified schematic of a parallel blocks embodiment for a postprocessing block according to an example.

FIG. 4B represents a simplified schematic illustrating a partial blocks embodiment for a postprocessing block according to an example.

FIG. 5 shows a flowchart of a method for training of postprocessing blocks according to an example.

FIG. 6 shows a flowchart of a method for reducing the size of a NN model according to an example.

FIG. 7 shows a flowchart of a method for using trained models at inference stage according to an example.

FIG. 8 shows a flowchart of a method for use in a radio receiver according to one or more example embodiments.

FIGS. 9A-9B shows results obtained with a model in a parallel block embodiment.

FIG. 10 is a block diagram illustrating an exemplary hardware structure of an apparatus according to an example.

It should be noted that these drawings are intended to illustrate various aspects of devices, methods and structures used in example embodiments described herein. The use of similar or identical reference numbers in the various drawings is intended to indicate the presence of a similar or identical element or feature.

### DETAILED DESCRIPTION

Detailed example embodiments are disclosed herein. However, specific structural and/or functional details disclosed herein are merely representative for purposes of describing example embodiments and providing a clear understanding of the underlying principles. However these example embodiments may be practiced without these specific details. These example embodiments may be embodied in many alternate forms, with various modifications, and should not be construed as limited to only the embodiments set forth herein. In addition, the figures and descriptions may have been simplified to illustrate elements and/or aspects that are relevant for a clear understanding of the present invention, while eliminating, for purposes of clarity, many other elements that may be well known in the art or not relevant for the understanding of the invention.

One or more example embodiments describe a method for use by a ML-based radio receiver and a corresponding ML-based radio receiver.

A radio receiver is configured to process, e.g. in frequency domain, a modulated radio signal that may be modulated according to one of a plurality of modulation schemes supported by the radio receiver.

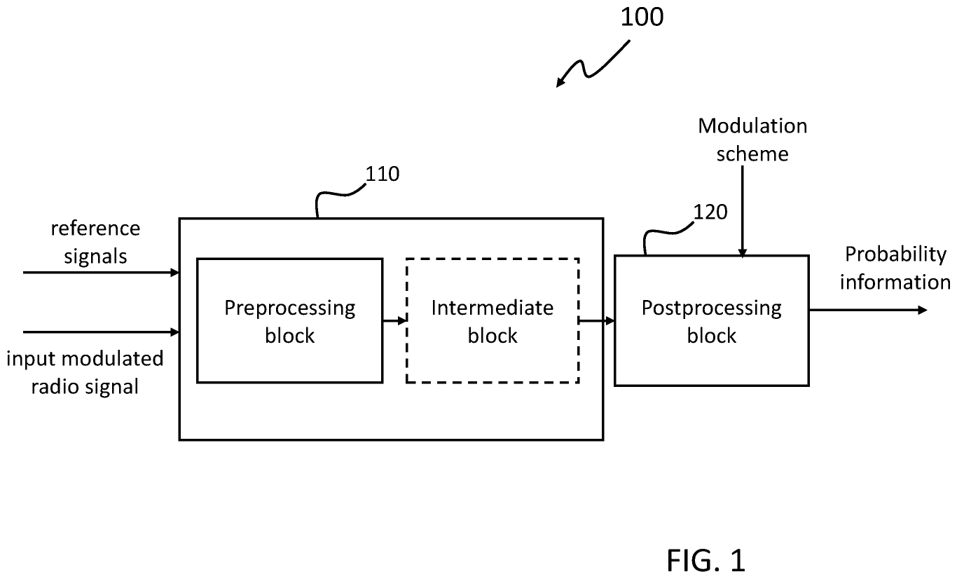

FIG. 1 represents a simplified schematic of a radio receiver according to an example.

The radio receiver 100 may include a signal processing chain of functional blocks configured to generate probability information (e.g. bit probabilities and/or log likelihood ratios, LLRs) for input bits encoded in an input modulated radio signal on the basis of one or more reference signals. The probability information may be used by one or more subsequent processing blocks (LDPC (Low Density Parity Codes), polar code, or turbo decoder, for example), e.g. to decode the input bits from the probability information.

The radio receiver 100 may support a plurality of modulation schemes and be configured to obtain (e.g. detect, read, compute, etc) the modulation scheme of the input bits in the input modulated signal. For example, a base-station may define a modulation scheme to be used for certain UE's uplink transmission, or it could be communicated by the radio emitter to the radio receiver 100 through a special control channel.

A modulation scheme (e.g. 16-QAM, 64-QAM, etc) is defined by a modulation type (e.g. QAM, QPSK, etc), corresponding to a modulation algorithm, and a modulation order (e.g. 16, 64, 128, 256, 512, etc), corresponding to a constellation size.

The signal processing chain in the radio receiver 100 includes:
a fixed part 110 that is common to all the modulation schemes supported by the radio receiver 100 and generates an intermediate signal; and
a variable part 120 that is dynamically configured based on the current modulation scheme of the input modulated radio signal and generates probability information from the intermediate signal.

The fixed part 110 may include a preprocessing function based on a trained software ML model, the preprocessing function being common to the plurality of modulation schemes supported by the radio receiver 100. The fixed part 110 may further include one or more signal processing functions that generate the intermediate signal from the input modulated signal based on one or more reference signals. The one or more signal processing functions may include for example an equalization function which applies, for example, MRC (maximum-ratio combining) or LMMSE type equalization.

The variable part 120 may be configured to execute a plurality of postprocessing functions. The variable part 120 may be configured to select one of the postprocessing functions to be executed based on the modulation scheme used for encoding the input bits in the input modulated signal. The selection may be performed based on the modulation type and/or the modulation order of the modulation scheme. The radio receiver 100 is configured to execute the selected postprocessing function using a corresponding postprocessing block. The variable part 120 is executed after the fixed part 110 in the signal processing chain. For each postprocessing function, the underlying ML model is trained for at least one respective modulation scheme among the modulation schemes supported by the radio receiver 100.

In the context of this document, a processing block (e.g. a postprocessing block or a preprocessing block) correspond to means for performing a corresponding processing function (e.g. a postprocessing function or a preprocessing function). For example, for a software implementation, a processing block may correspond to a memory block storing instructions that when executed by a processor cause the radio receiver 100 to execute the corresponding processing function.

Each postprocessing function may be based on a trained software ML model. The preprocessing function may also be based on a trained software ML model. The ML model used for a preprocessing block or a postprocessing block may be a NN (e.g. a deep learning NN, DLNN). The NN may also be a convolutional NN, CNN, or a Transformer network, or any other neural network type.

Generally, a ML model may be a data driven algorithm that may be tuned based on data collection used as training dataset by applying machine learning techniques and that is configured to generate a set of outputs (e.g. predicted information and/or decision parameters) based on a set of inputs. The training of a ML model may be a process to train the ML model to adjust model coefficients based on one or more optimization criteria to get a trained ML model for inference. An inference may be a process of using a trained ML model to generate a set of outputs based on a set of inputs (e.g. to make a prediction or guide the decision based on collected input bits).

To avoid using excessive computation resources for processing the modulated radio signal when low modulation orders are used, the radio receiver 100 may be configured to select a postprocessing function among a plurality of postprocessing functions supported by the radio receiver 100, the selected postprocessing function being trained for postprocessing of a signal modulated according to the modulation scheme used for the input modulated radio signal.

Each of the plurality of postprocessing functions may be based on a postprocessing NN that is trained for postprocessing of a modulated radio signal modulated according to a respective modulation scheme in the plurality of modulation schemes.

In embodiments, some layers of a given ML model of a postprocessing block could be shared between two or more modulation schemes such that the postprocessing block is configured to implement several postprocessing functions and such that memory consumption is further reduced. For example, different depths (e.g. a variable number of additional layers in addition to the shared layers) of the ML model may be trained for different modulation schemes, where the depth to be used for a given modulation scheme may be selected based on the best validation results obtained during training of the models with the different depths.

Each trained model may be trained optimally for a given modulation order. This way it is possible to cover the most complex use case with high constellation size while simultaneously ensuring that the relatively simpler and more frequent cases with low constellation size are processed with the minimal number of computations that guarantees optimal accuracy.

As the same time, the ML-receiver may include a trained postprocessing model that is trained to support modulation scheme with the highest modulation order (e.g. 256-QAM) in order to guarantee that such modulation scheme is supported.

The benefit of the use of a fixed part 110 with a variable part 120 is—compared to fully switching to a different processing chain—that part of the processing chain is shared between the modulation schemes. This drastically reduces the necessary computation resources (e.g. the memory consumption by the processing blocks and the computation time at inference stage) while allowing fast switching between different modulation schemes, which is critical in the case of receiving multiple modulation schemes to ensure a lower latency in processing.

In embodiments (referred to herein as the parallel blocks embodiments), the postprocessing functions are implemented by parallel postprocessing blocks, the variable part 120 being configured to select one these parallel postprocessing blocks based on the modulation scheme of the input modulated radio signal, such that only one of the parallel postprocessing blocks is run at a time.

In the parallel blocks embodiments, the training of each postprocessing ML model may be done with the same initial preprocessing ML model which is fully pre-trained on the most advanced modulation schemes (256-QAM) with the highest modulation order. During training, this approach enables faster and easier iterations since it focuses on the postprocessing step to support additional modulation schemes instead of requiring full end-to-end training. Alternatively, all postprocessing ML models could be trained simultaneously, in which case the advantage is that the preprocessing ML model is optimized for all modulation schemes.

In other embodiments (referred to herein as the partial blocks embodiments), the postprocessing functions are implemented by a same postprocessing block (thus a same ML model), in which some parts may be deactivated based on the modulation scheme of the input modulated radio signal, such that only some computation functions implemented by the postprocessing block are used for some modulation schemes with lower modulation order while no computation function of the postprocessing block are deactivated for the modulation scheme with the highest modulation order.

The partial blocks embodiments allow the use of a single model whose amount of computations is adjusted according to the modulation scheme e.g., by running only partial layers for lower modulations and outputting zero from the other deactivated layers. In the partial blocks embodiments, all the parameters needed to deal with every modulation is contained in a single model which is designed to allow selection of the right part of the model: thus there is no need to load a different model when the modulation changes so even if multiple modulations are mixed in the same sample, the modulations can all be processed efficiently. Another advantage of the partial blocks embodiments is that memory is saved, since all the postprocessing functions share parts of the same layers (e.g., some filters) between the modulation schemes.

In the parallel blocks embodiments and the partial blocks embodiments, a postprocessing function that corresponds to a modulation scheme different than the modulation scheme with the highest modulation order is based on a reduced version of a same NN model trained for the highest modulation order. Average power consumption is drastically lowered since large portion of the transmissions (especially uplink transmissions) usually use lower modulation orders.

For example, for a given modulation type, the plurality of postprocessing functions may include:
a first postprocessing function that is adapted for postprocessing of a signal modulated according to a first modulation scheme having a first modulation order;
a second postprocessing function that is adapted for postprocessing of a signal modulated according to a second modulation scheme having a second modulation order smaller than the first modulation order.

The second postprocessing function, having a modulation order smaller than the highest modulation order, may use less computation resources than the first postprocessing function. For example, the first postprocessing function is based on a first NN and the second postprocessing function is based on a second NN that is a reduced (e.g. simplified) version of the first NN.

When processing an input modulated signal with low constellation size, such as 16-QAM, it is possible to achieve sufficient accuracy with substantially reduced computation. Because the highest modulation order represents only a small fraction of all received data, this represents a significative reduction of the computation.

This allows to achieve optimal radio performances for a variety of modulation schemes with substantially decreased average computation for lower modulation orders and thus lower average power usage. The ML-receiver is thus configured to dynamically select a trained postprocessing block between different trained postprocessing blocks based on the modulation scheme (e.g. modulation order and/or modulation type) of the input modulated radio signal.

In all embodiments, a significantly reduced average complexity in terms of number of operations (e.g. tera operations, TOPS) is achieved. Since the TOPS complexity is currently one of the most significant metrics for the feasibility of a radio receiver 100 that uses ML models with strict requirements in terms of latency and power budget, the approach presented herein is valuable when integrating ML-model in next generation (e.g. 5G radio receiver 100) of radio receiver 100.

The approach disclosed herein can be used with any ML-based radio receiver 100 and will be described in detail in the context of a ML-based radio receiver 100 which includes a CNN-based preprocessing block (“PreDeepRx”) and CNN-based postprocessing block (“PostDeepRx”).

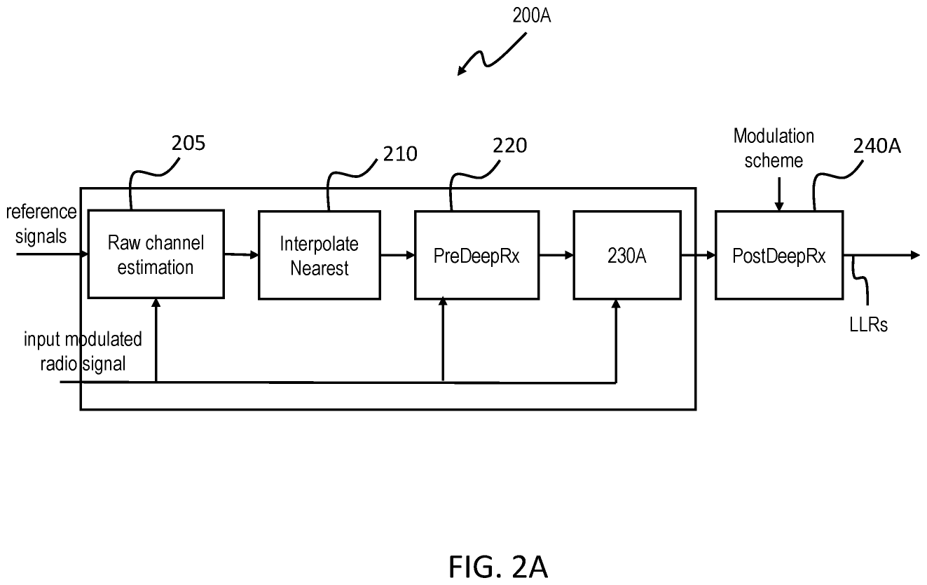

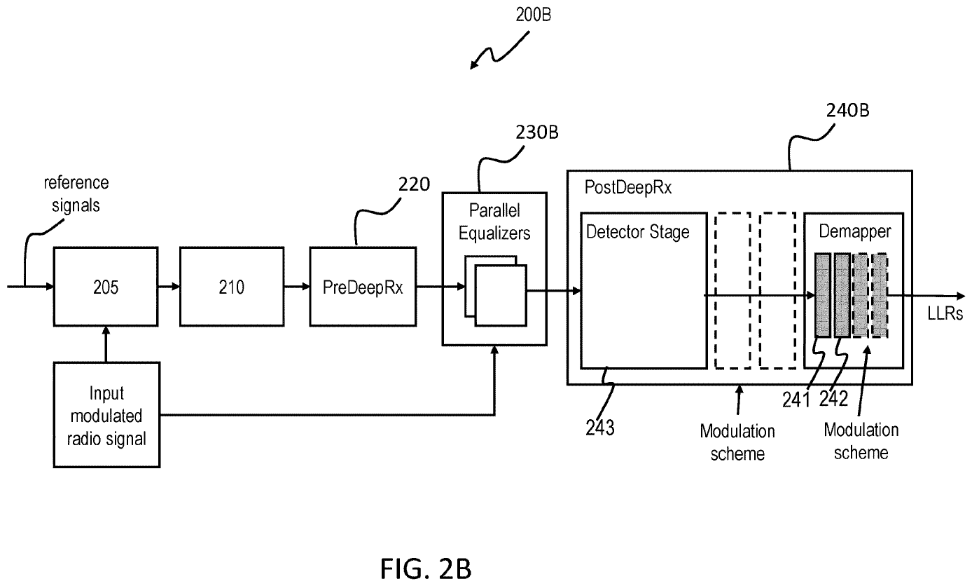

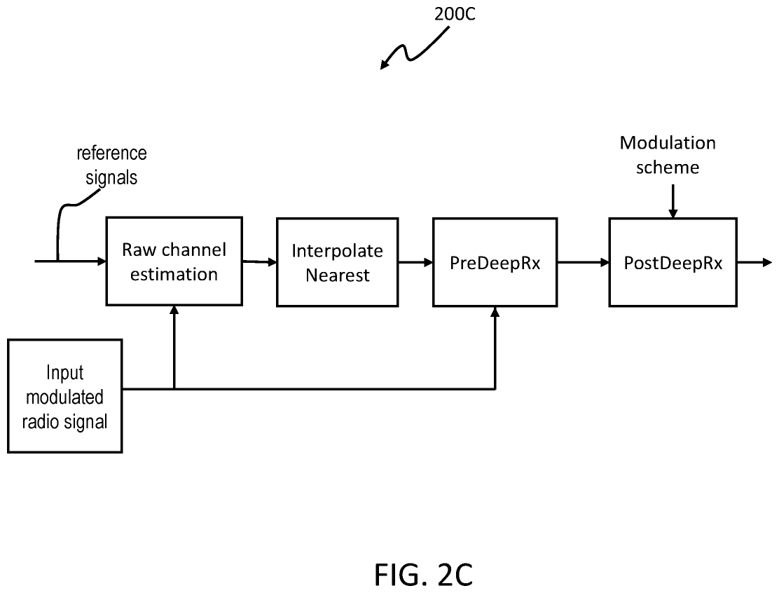

FIG. 2A shows a radio receiver 200A adapted for MIMO transmission according to an example.

The radio receiver 200A includes a signal processing chain configured to generate, from one or more reference signals and an input modulated radio signal, probability information (e.g. bit probabilities and/or log likelihood ratios, LLRs) for input bits encoded in the input modulated radio signal. The radio receiver 200A receives reference signals that may be used for channel estimation.

The radio receiver 200A includes a processing chain including:
a raw channel estimation block 205, configured to perform raw channel estimation based on reference signals (e.g. demodulation reference signals, DMRS) and the input modulated radio signal;
an interpolation block 210, configured to perform interpolation, for example, nearest neighborhood interpolation or linear interpolation;
a preprocessing block, PreDeepRx 220;
an intermediate block 230A for equalization or non-linear processing; and
a postprocessing block, PostDeepRx, 240A.

As trainable components, the radio receiver 200A includes a NN-based preprocessing block “PreDeepRx” 220 and a NN-based postprocessing block “PostDeepRx” 240A. Between these preprocessing and postprocessing blocks, the intermediate processing block 230A generates at least one intermediate signal fed to the postprocessing block “PostDeepRx”.

A PreDeepRx block may process input bits between the input blocks and the intermediate processing block. A PreDeepRx block may perform preprocessing operations such as processing channel estimates, channel smoothing and averaging. The PreDeepRx block may include one or more series of ResNet blocks (residual network, ResNet).

A PostDeepRx block may process input bits after the intermediate processing block. A PostDeepRx block may perform one or more postprocessing operations such as symbol detection or demapping. The PostDeepRx block may include one or more series of ResNet blocks.

The intermediate processing block may be any block performing non-linear operation or equalization. The intermediate processing block may for example be an equalization block, e.g. an approximative LMMSE equalizer, which provides expert knowledge allowing to train a model with good performance without significant increase in model size. The intermediate processing block may for example be an exact LMMSE or a MRC (maximum-ratio combining).

FIG. 2B shows a radio receiver 200B adapted for MIMO transmission according to an example.

The radio receiver 200B includes a processing chain including:
a raw channel estimation block 205, configured to perform raw channel estimation based on reference signals (e.g. demodulation reference signals, DMRS) and the input modulated radio signal;
an interpolation block 210;
a preprocessing block PreDeepRx 220;
an equalization block 230B; and
a postprocessing block PostDeepRx 240B.

In this example, the PreDeepRx block includes for example N ResNet blocks with a series of convolutional layers in the ResNet block. Each convolutional layer may use different numbers of convolutional filters generating corresponding output channels.

The PostDeepRx block includes here a detector stage 243 and a chain of demapper stages 241, 242. Each detector stage may comprise a chain of ResNet blocks. Each ResNet block may include different numbers of convolutional layers (e.g. 1 D, 2D, or 3D convolutional layers). Each convolutional layer may use different number of convolutional filters generating corresponding output channels. The relationship between convolutional filters and the output channels depends on the type of convolutional operation. The demapper may include a chain of ResNet blocks.

FIG. 2C shows a radio receiver in an alternative embodiment without intermediate processing block between the preprocessing block and the post processing block.

The partial blocks and parallel blocks approaches discloses herein may also be applied to a radio receiver without an intermediate processing block between the preprocessing block and the postprocessing block, e.g. without an equalizer. For example, in SIMO or SISO cases, this kind of radio receiver without an equalizer performs well. Also for MIMO, an architecture that includes non-linear blocks throughout the architecture may be used.

In this case, the first part (corresponding to a preprocessing block) of the radio receiver that is closest to the input can be fixed and independent of the modulation scheme, while the end part (corresponding to a postprocessing block) of the radio receiver can be variable and dynamically configured based on the modulation scheme. The exact splitting point between the fixed part and the variable part may be determined similarly to any other hyperparameter, namely selecting the location that performs best on independent validation data.

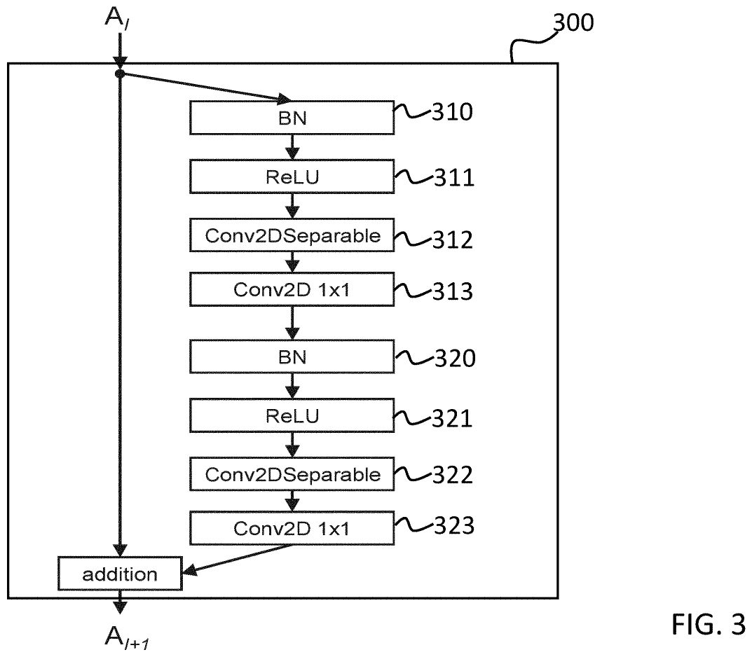

FIG. 3 shows a ResNet block according to an example.

The ResNet block includes two series of computation blocks. Each series may include at least one of a batch normalization (BN) 310, 320, a rectified linear (ReLu) activation function 311, 321, and two or more convolution operations 312, 313, 321, 323. At least one of these convolution operations may be a 1×1 convolutional layer 313, 323. The type of computation blocks in a ResNet block may vary, as well as the number of ResNet blocks in a preprocessing and postprocessing block. In a ResNet block, the output of the last convolution operation in the ResNet block is added to the input of the ResNet block as illustrated by FIG. 3.

Advantages of ResNet blocks may include being numerically stable to train even when the number of ResNet blocks is large.

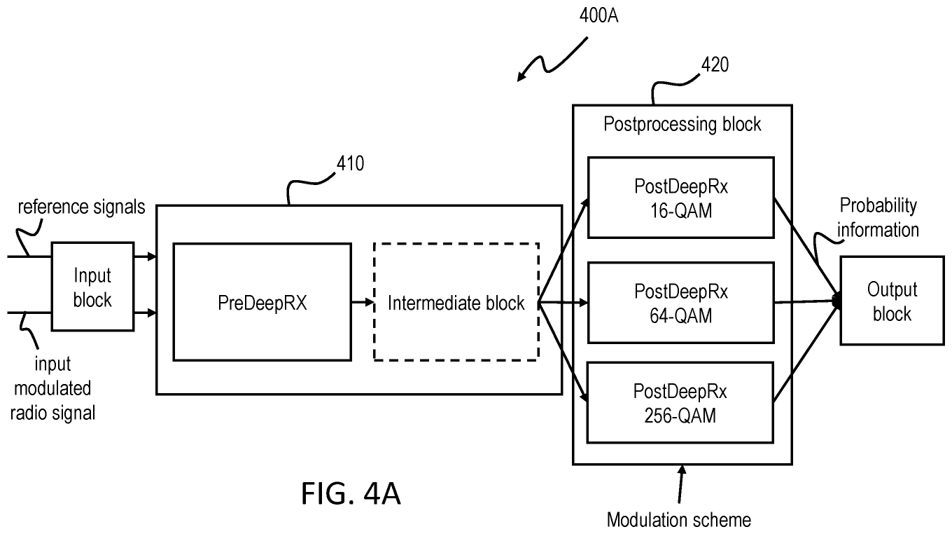

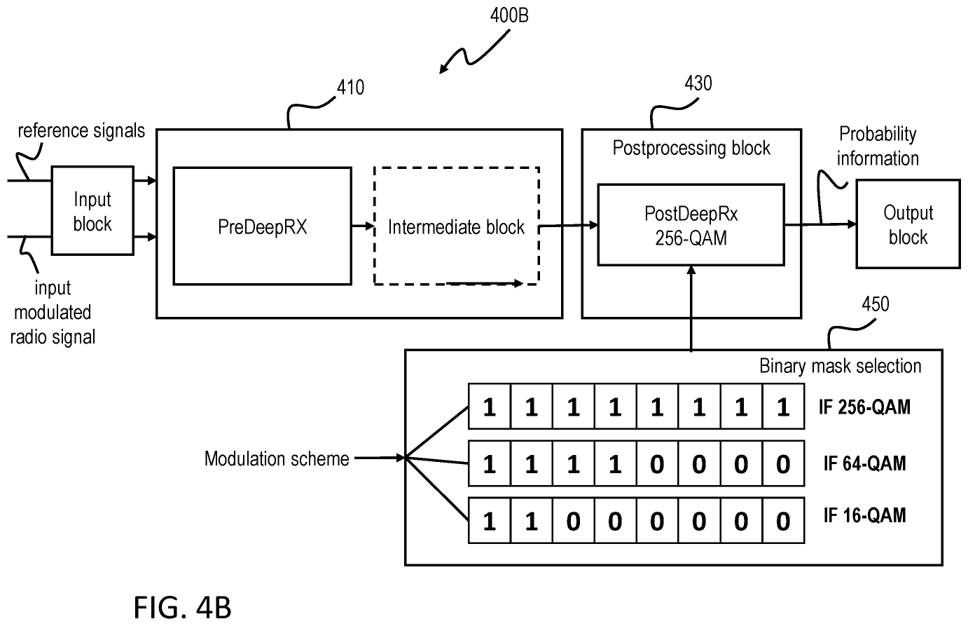

FIG. 4A is a simplified schematic of a parallel blocks embodiment according to an example.

In this example, three modulation schemes (16/64/256QAM) are used to illustrate that a fixed part 410 of the processing chain may be shared between different modulation schemes (here the PreDeepRx and intermediate blocks) and independent of the current modulation scheme, while a variable part 420 of the processing chain (here the PostDeepRx block) is configured per modulation scheme with three selectable postprocessing blocks (PostDeepRx 16-QAM, PostDeepRx 64-QAM, PostDeepRx 256-QAM). Only one of the parallel postprocessing blocks is run at a time at inference stage.

FIG. 4B represents a simplified schematic illustrating a partial blocks embodiment according to an example.

Since the different modulations are subsets of each other, the first bits of 16-QAM are represented in same way in 256-QAM in the IQ data. Based on this, it appears possible to use, for the partial blocks embodiments, a single postprocessing block and a single model for all modulations schemes (e.g. all modulation orders). However, for lower modulation orders, only a selected range of output channels in convolutions of the postprocessing block is used and the others are not used. In other words, the output channels of the convolutions are activated or deactivated depending on the modulation order of input bits. By this way, the model capacity varies dynamically as a function of the modulation scheme of the input bits. There is no need to load weights when the modulation order changes, only to activate or deactivate corresponding parts. This allows to achieve memory consumption reduction for multiple modulation schemes.

For example, the full layers may only be run for the largest supported modulation order and for lower modulation orders, only a selected range of convolutional filters and output channels in one or more or each convolutional layer or, at least, in the last convolutional layer may be run and the other parts are considered to produce zero output.

The activation or deactivation of parts of the postprocessing block could be achieved by e.g., the use of activation or deactivation binary values (e.g. stored in a binary mask) that would only allow output channels of the postprocessing block to be activated or deactivated. The use of this kind of binary mask can be applied during the training to simplify training procedure. On the other hand, the binary mask solely does not reduce computations. Therefore, for the deployment of the model, the inference processor may be configured to turn off and/or skip the computations for the output channels and corresponding convolutional filters that are deactivated.

FIG. 4B provides a simplified representation of a dynamic masking implementation for 16/64/256QAM highlighting how the postprocessing block may be fixed but with multiple binary masks applied depending on the modulation scheme of the input bits.

In FIG. 4B there is a fixed part 410 of the processing chain that is shared between different modulation schemes (the fixed part including here the PreDeepRx and intermediate blocks) and independent of the current modulation scheme, while a variable part 430 of the processing chain (here the PostDeepRx block) is configured per modulation scheme with only one postprocessing block but several binary masks 450. Only one of the binary mask is selected at a time and is applied to the postprocessing block 430.

The sizes of the binary masks and total amount of filters can be considered as hyperparameters and chosen at development time based on validation results, similarly to the parallel block embodiments.

The partial blocks approach limits the amount of computation used for some modulation schemes with low modulation order with the additional benefit of reduced memory use and processing latency savings because the weights are shared between different modulation schemes and do not need to be fetched from memory when multiple modulations are used.

The partial blocks approach disclosed herein is described for separable convolutions. Separable convolutions may be used as they allow simpler presentation and give good performance in ML-based radio receivers with reduced computational burden (compared to normal convolutions in ML tools). However, the approaches disclosed herein can be applied to other type of convolutions. Separable convolutions are shortly described below.

The input of the convolution may be a F×S×N matrix where F is the number of subcarriers, S is the number of symbols, and N number of channels (here, for simplification reasons batch dimension, which is related to practical implementation, is omitted)

With separarable convolution, the below operations are performed:
Depthwise convolution: each channel of the input is 2D-convolved with a W×V convolutional filter (i.e. there are N convolutional filters). Output is F×S×N (assuming zero padding or other padding which keeps the same resolution);
Pointwise or 1×1 convolution: this the convolution with M convolutional filters such that filter size is 1×1. By using 1×1 convolutional filters each sample (e.g. radio resource element) is multiplied with the (same) M×N matrix.
Weights may be learned: W*V*N filters and M*N matrix.

The idea is to limit number of active convolutional filters (N) based on the modulation scheme.

This can be achieved by multiplying (element wise) the input with a binary mask M with F×S×N elements such that M=concat(O, Z) (concatenation in third dimension corresponding to channel) such that:
O is a F×S×A array of ones;
Z is a F×S×(N−A) array of zeros.

Such binary mask M forces only A convolutional filters of the convolutional layer to be active (because other input channels are 0 after multiplying with the binary mask). The binary mask A may depend on the modulation scheme. For example:
If input bits processed corresponds to 256-QAM, we can choose A=N (i.e. all output channels are active);
If input bits processed corresponds to 64-QAM, we can choose A=N/2;
If input bits processed corresponds to 16-QAM, we can choose A=N/4;

Computational saving comes from the fact that for e.g. 16-QAM we need to apply only ¼th of filters when convolutions are computed.

In practice, the exact number of active layers for lower order of modulations needs may be tuned at learning stage.

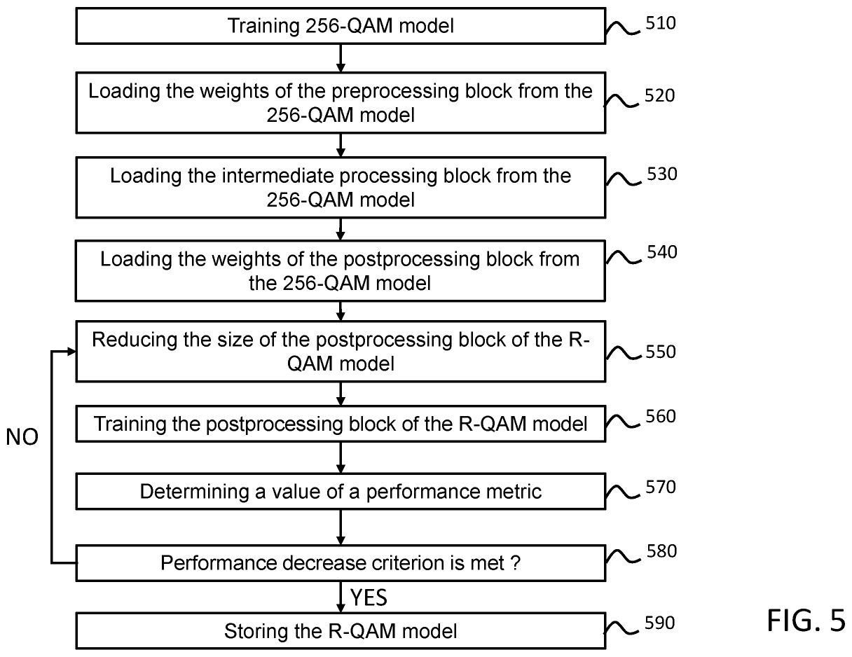

FIG. 5 shows a flowchart of a method for training of postprocessing blocks in the parallel blocks embodiments.

In step 510, the radio receiver is trained to support the modulation scheme with the highest modulation order (e.g. 256-QAM). The training may be carried out using the training procedure described below with training data containing only samples with 256-QAM modulation. This training generates the weights for the NN model for 256-QAM (hereafter the 256-QAM model), both for the PreDeepRx block and a first postprocessing block in the PostDeepRx: these weights are denoted respectively as

$${w}_{Pre}^{256 - QAM} and {w}_{Post}^{256 - QAM} .$$

For every other modulation scheme R-QAM (where R-QAM is the considered modulation scheme, R being the modulation order, e.g. 16-QAM and 64-QAM) to support, the steps 520 to 590 may be performed for training of a corresponding postprocessing block to generate a R-QAM model.

In step 520, the weights of the PreDeepRx block from the 256-QAM model are loaded. This means that the PreDeepRx block for the other modulation schemes has the same NN model structure and weights

$$( i . e .. {w}_{Pre}^{R - QAM} = {w}_{Pre}^{256 - QAM} ) .$$

In step 530, the intermediate processing block (e.g. equalizer block), if any, from the 256-QAM model is loaded.

In step 540, the weights of the postprocessing block from the 256-QAM model are used for the considered postprocessing block for the considered modulation scheme R-QAM: this means that the considered postprocessing block, before training, has the same NN model structure and weights as in the trained 256-QAM model.

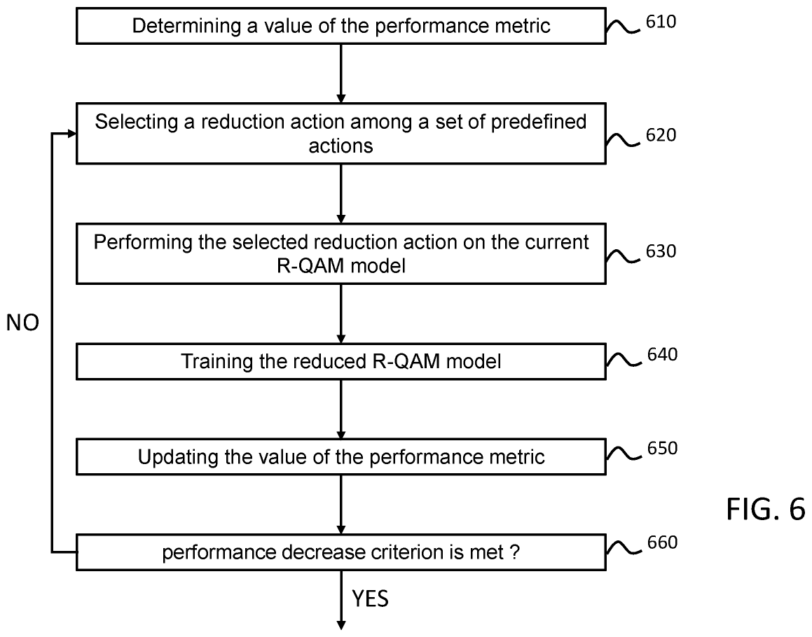

In step 550, the size of the considered postprocessing block is reduced. An example method for size reduction is disclosed by reference to FIG. 6.

In step 560, a training of the reduced postprocessing block of the R-QAM model is performed while the preprocessing block from the 256-QAM model is frozen (i.e. the weights

$${w}_{Pre}^{R - QAM}$$

are not updated during training).

In step 570, a validation procedure is run to determine an initial value of a performance metric Perf_init for the R-QAM model.

For a given modulation order, steps 550-570 are repeated until a performance decrease criterion is met for the performance metric (e.g. the performance metric starts decreasing).

In step 580, when the performance decrease criterion is met, the training process ends and the weights of the last postprocessing block obtained for the R-QAM model after training in step 560 and the weights of the preprocessing block of the 256-QAM model are stored for the R-QAM model.

In step 590, the R-QAM model obtained by combining the weights of the preprocessing block of the 256-QAM model and the weights of the postprocessing blocks obtained for the different R-QAM model is stored.

Steps 510 to 590 are repeated for the other modulation orders until all models for all modulation orders are trained, these models forming a complete trained parallel model supporting all the modulation orders with trained parallel postprocessing blocks.

Instead of training first the 256-QAM model and then training the other R-QAM models as disclosed by reference to FIG. 5, all postprocessing blocks and the shared preprocessing block may be trained at the same time using training data having all modulation schemes to be supported. In this case, during a forward pass in training, a postprocessing block is selected for each sample based on the modulation of the current input training data. This has the additional benefit of making sure the shared preprocessing block is optimized for all modulations. This training method also works for the partial blocks embodiments since a same postprocessing block is shared for all modulation schemes and have to be trained using training data with all modulation schemes to be supported.

For partial blocks, training may be done as done for the 256-QAM model, but the modulation specific binary mask is applied to outputs of the convolutional layer as described above. The binary mask takes care of selection of convolution filters and/or output channels.

Various embodiments can be used for the training procedure and the performance validation.

The radio receiver may be trained using training data as disclosed for example by Honkala et al. [“DeepRx: Fully Convolutional Deep Learning Receiver,” in IEEE Transactions on Wireless Communications, vol. 20, no. 6, pp. 3925-3940, June 2021. Also available in arXiv: 2005.01494]. Training data may include either simulated or collected field training data (with varying modulations). The model may be trained by optimizing the binary cross entropy (CE) calculated at the radio receiver output which can be expressed as in Honkala et al.:

$$CE ( b , \hat{b} ) = - \frac{1}{\# DB} {\sum }_{( i , j ) ∈ D} {\sum }_{l = 0}^{B - 1} ( {b}_{ijl} log {\hat{b}}_{ijl} + ( 1 - {b}_{ijl} ) log ( 1 - {\hat{b}}_{ijl} ) )$$

where D is the set of indices corresponding to radio resource elements carrying input bits, #D is the number of such indices, i and j are radio resources element indexes, B is the number of samples in the sample batch, l is the sample index, bᵢⱼₗ are the input data bits and \hat{b}ᵢⱼₗ are the predicted bit probabilities (\hat{b}ᵢⱼₗ=sigmoid (Lᵢⱼₗ) where Lᵢⱼₗ is the probability information for the radio resource element i,j and sample l, e.g. LLRs) at the output of the NN. The loss function can also include multiple CE terms or additional regularizing loss terms. Finally the model (i.e. the weighs of model and other trainable components) is saved.

The performance may be validated by using a validation dataset which is generated or collected separately or split from original training dataset. The performance metric computed for the validation dataset can be chosen, for example, as average BER or BER at 25 dB SNR.

FIG. 6 shows a flowchart of a method for reducing the size of a NN model according to an example.

This method may be used for parallel blocks embodiments.

This method may be used for example for the DeepRx architecture shown in FIG. 2B, where the postprocessing block include several decoding stages and a demapper. In this example, we assume that each decoder stage (respectively the demapper) includes one or more ResNet blocks, each ResNet block correspond to a series of computation blocks as represented by reference to FIG. 3. Each ResNet block may include one or more CNN, each CNN including one or more convolutional layers, each convolutional layer using one or more convolution filters and generating corresponding output channels.

In step 610, the value of the performance metric Perf_init is determined as disclosed for example by reference to FIG. 5. The current state of the R-QAM model is noted DeepRx_current and is used as the initial state DeepRx_init.

In step 620, a reduction action is chosen among a set of predefined actions. The reduction action may be either a reduction of the number of detector stages when the detector includes several detector stages and/or a reduction of the number of decoder stages when the decoder includes several decoder stages. In alternative or in addition, the reduction may be a reduction of the number of convolutional layers in one or more CNNs in one or more ResNet blocks and/or a reduction of the number of convolutional filters and/or output channels in one or more convolutional layers in one or more CNNs in one or more ResNet blocks.

In step 630, the selected reduction action is performed on the current R-QAM model. A reduction factor may be applied to compute the number of detector stages, layers or filters after the reduction action.

In step 640, the reduced R-QAM model is trained with the frozen preprocessing block of the 256-QAM model (i.e. the weights

$${w}_{Pre}^{R - QAM}$$

are not updated) as disclosed for example by reference to FIG. 5.

In step 650, a validation procedure is run to determine the current value Perf_new of a performance metric for the R-QAM model. If a performance decrease criterion is met (for example if Perf_new<Perf_init+threshold), the reduction process ends and the current model DeepRx_current is saved and used as the model for R-QAM.

In step 660, the performance decrease criterion is checked. If the performance decrease criterion is not met, steps 620-650 may be repeated again.

Optionally, the reduction process may be enhanced by having adaptive reduction factor: first, the reduction factor can be larger and then, this reduction factor may be reduced if the performance was observed to decrease (or to decrease too fast) in step 660.

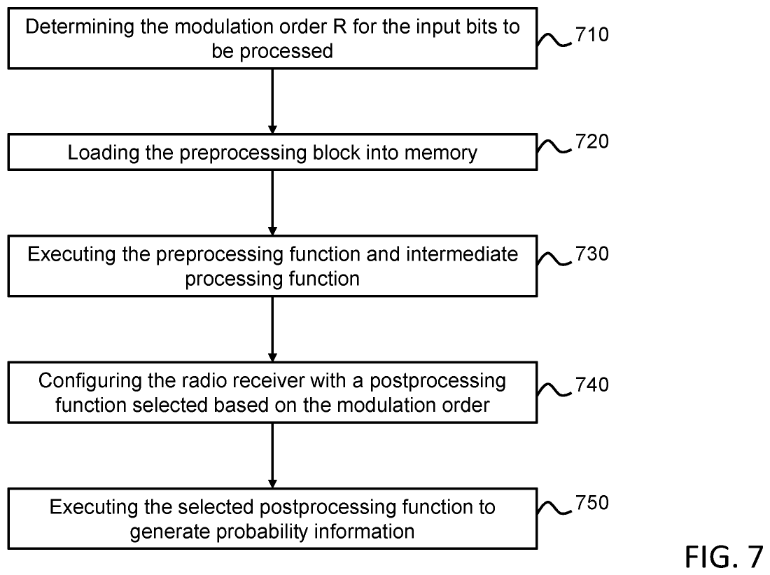

FIG. 7 shows a flowchart of a method for using the trained R-QAM models at inference stage.

This method may be used for parallel blocks embodiments.

In step 710, the modulation order R for the input bits to be processed is determined. For example R=16.

In step 720, the preprocessing block is prepared for execution, e.g., by loading its weights to memory if the weights are not loaded already from the previous inference.

In step 730, the preprocessing function of the preprocessing block and the intermediate processing function (e.g. equalization) of the intermediate processing block, if any, are executed for the input bits to generate an intermediate signal (e.g. an equalized signal).

In step 740, the radio receiver is configured with a postprocessing function selected based on the modulation order. For example, in the parallel blocks embodiments, a version of the postprocessing block is selected based on the modulation order R, and its weights are loaded to memory if they are not loaded already from the previous inference.

In step 750, the selected postprocessing function is executed using the intermediate signal as its input to generate the receiver output, probability information.

For the partial blocks embodiment, parts of the postprocessing block are shared at inference stage between the different modulation orders (for example, when the first layers of the postprocessing block are very similar between the modulation orders), these shared parts do not need to be switched or loaded again when the modulation order changes at inference stage, only the deactivation binary masks are applied to the postprocessing block. This allows to further decrease the memory consumption and reduce the processing latency due to the loading of weights when the modulation order changes.

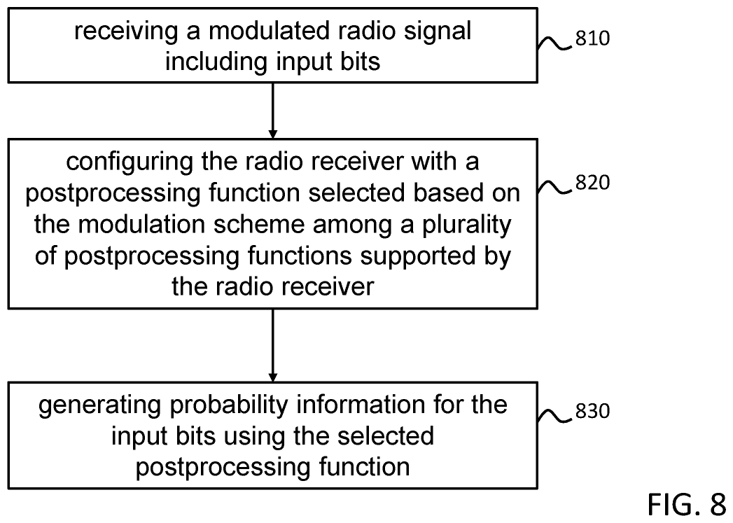

FIG. 8 shows a flowchart of a method for use in a radio receiver according to one or more example embodiments.

The steps of the method may be implemented by a radio receiver according to any example described herein. While the steps are described in a sequential manner, the man skilled in the art will appreciate that some steps may be omitted, combined, performed in different order and/or in parallel.

In step 810, a modulated radio signal including input bits is received by the radio receiver. The input bits are modulated in the input radio signal according to a modulation scheme in a plurality of modulation schemes supported by the radio receiver.

In step 820, the radio receiver is configured with a postprocessing function selected based on the modulation scheme among a plurality of postprocessing functions supported by the radio receiver.

Each of the plurality of postprocessing functions is based on a postprocessing neural network, NN. Each of the plurality of postprocessing functions is trained for postprocessing of a signal modulated according to a respective modulation scheme in the plurality of modulation schemes. The selected postprocessing function is trained for postprocessing of a signal modulated according to said modulation scheme.

In step 830, probability information for the input bits are generated using the selected postprocessing function.

Generating the probability information may include: generating an intermediate signal from at least the modulated radio signal; performing postprocessing on the intermediate signal to generate the probability information using the selected postprocessing function.

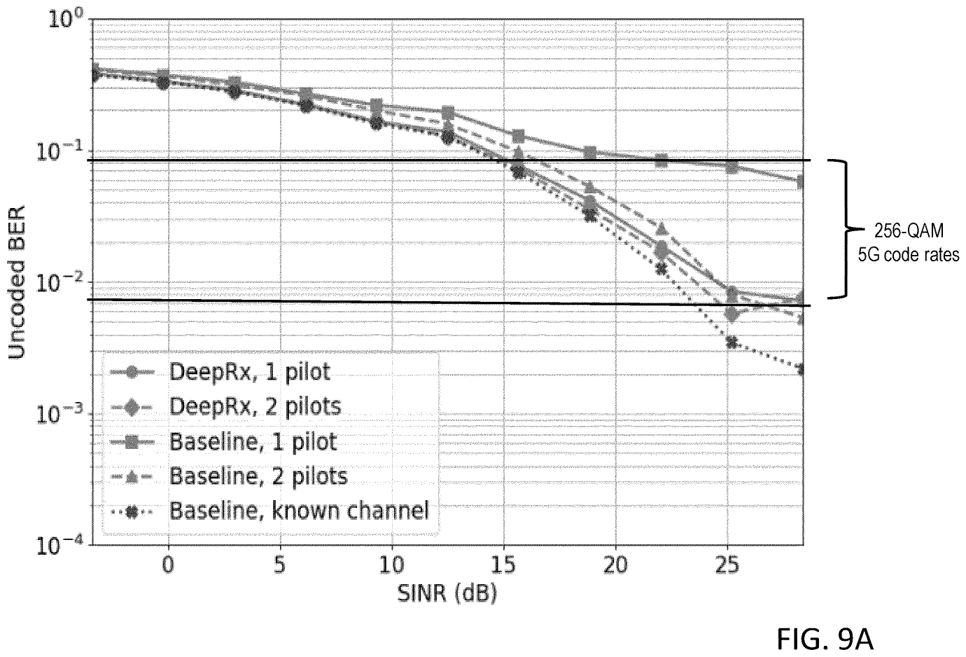

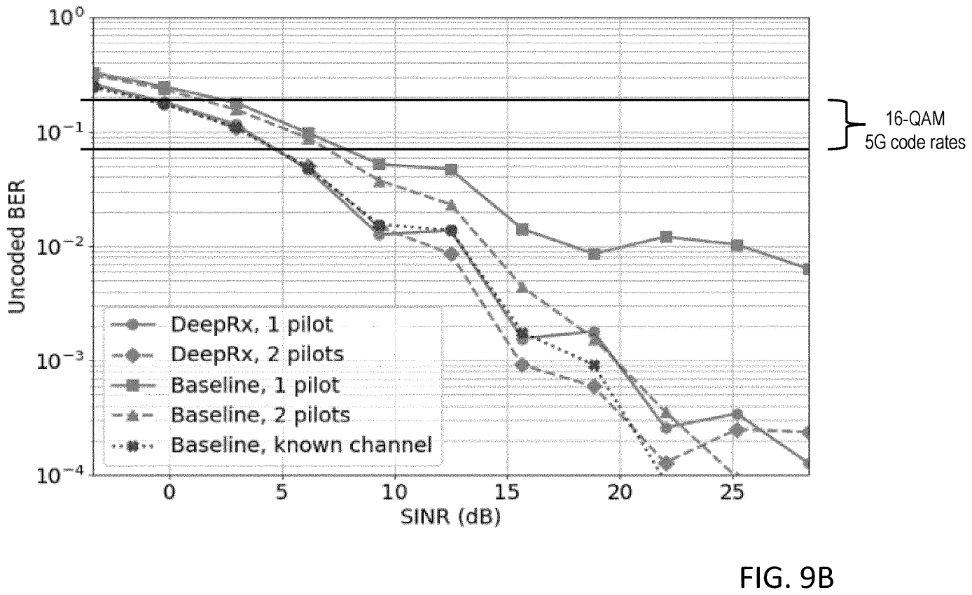

Simulation results are showed by the graphs of FIG. 9A-9B for different model complexities at 100 MHz for 16-QAM and 256-QAM. The graphs show the variation of the uncoded BER as a function of the SINR (Signal to Interference plus Noise Ratio). Each graph shows a region (“waterfall region”) for 5G code rates in which the uncoded BER has to fall to allow the LDPC decoding.

The graphs present simulation results for a trained 4×2 MIMO ML receiver models with 256-QAM and 16-QAM models, with respectively 1 or 2 pilots (reference signals). The baseline corresponds to a typical LMMSE receiver.

The computational complexity corresponds to the model total complexity, with fixed and variable parts.

FIGS. 9A-9B shows results obtained with a model (DeepRx) in a parallel block embodiment. The model complexity was chosen to fit the most complex modulation scheme 256-QAM and then by reducing the model complexity for the modulation scheme 16-QAM. As shown, no significant degradation of the uncoded BER is obtained for both modulation schemes while computational resources are reduced.

It should be appreciated by those skilled in the art that any functions, engines, block diagrams, flow diagrams, state transition diagrams, flowchart and/or data structures described herein represent conceptual views of illustrative circuitry embodying the principles of the invention. Similarly, it will be appreciated that any flow charts, flow diagrams, state transition diagrams, pseudo code, and the like represent various processes.

Although a flow chart may describe operations as a sequential process, many of the operations may be performed in parallel, concurrently or simultaneously. Also some operations may be omitted, combined or performed in different order. A process may be terminated when its operations are completed but may also have additional steps not disclosed in the figure or description. A process may correspond to a method, function, procedure, subroutine, subprogram, etc. When a process corresponds to a function, its termination may correspond to a return of the function to the calling function or the main function.

Each described function, engine, block, step described herein can be implemented in hardware, software, firmware, middleware, microcode, or any suitable combination thereof.

When implemented in software, firmware, middleware or microcode, instructions to perform the necessary tasks may be stored in a computer readable medium that may be or not included in a host device or host system. The instructions may be transmitted over the computer-readable medium and be loaded onto the host device or host system. The instructions are configured to cause the host device or host system to perform one or more functions disclosed herein. For example, as mentioned above, according to one or more examples, at least one memory may include or store instructions, the at least one memory and the instructions may be configured to, with at least one processor, cause the host device or host system to perform the one or more functions. Additionally, the processor, memory and instructions, serve as means for providing or causing performance by the host device or host system of one or more functions disclosed herein.

The host device or host system may be a general-purpose computer and/or computing system, a special purpose computer and/or computing system, a programmable processing apparatus and/or system, a machine, etc. The host device or host system may be or include or be part of: a user equipment, client device, mobile phone, laptop, computer, network element, data server, network resource controller, network apparatus, router, gateway, network node, computer, cloud-based server, web server, application server, proxy server, etc.

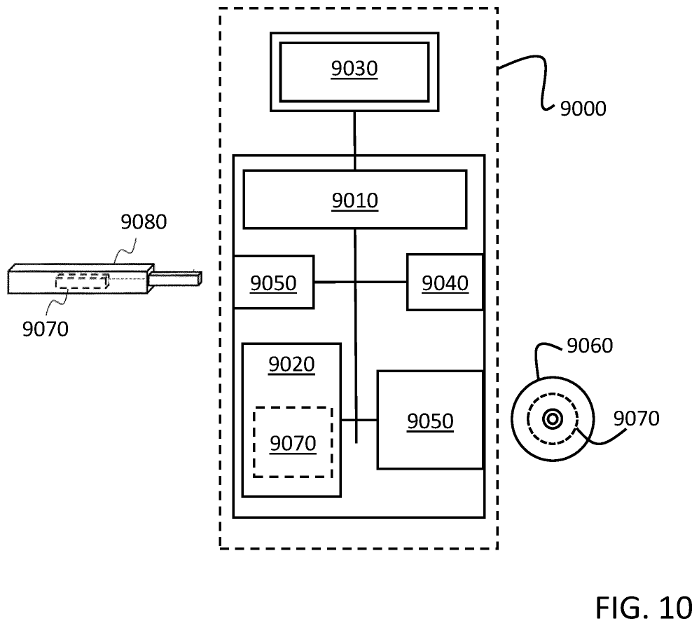

FIG. 10 illustrates an example embodiment of an apparatus 9000. The apparatus 9000 may be a radio receiver as disclosed herein.

The apparatus 9000 may be used for performing one or more or all steps of a method disclosed herein. The apparatus 9000 may be used for implementing one or more blocks of a radio receiver disclosed herein.

The apparatus 9000 may include at least one processor 9010 and at least one memory 9020. The apparatus 9000 may include one or more communication interfaces 9040 (e.g. network interfaces for access to a wired/wireless network, including Ethernet interface, WIFI interface, etc) connected to the processor and configured to communicate via wired/non wired communication link(s). The apparatus 9000 may include user interfaces 9030 (e.g. keyboard, mouse, display screen, etc) connected with the processor. The apparatus 9000 may further include one or more media drives 9050 for reading a computer-readable storage medium (e.g. digital storage disc 9060 (CD-ROM, DVD, Blue Ray, etc), USB key 9080, etc). The processor 9010 is connected to each of the other components 9020, 9030, 9040, 9050 in order to control operation thereof.

The memory 9020 may include a random access memory (RAM), cache memory, non-volatile memory, backup memory (e.g., programmable or flash memories), read-only memory (ROM), a hard disk drive (HDD), a solid state drive (SSD) or any combination thereof. The ROM of the memory 9020 may be configured to store, amongst other things, an operating system of the apparatus 9000 and/or one or more computer program code of one or more software applications. The RAM of the memory 9020 may be used by the processor 9010 for the temporary storage of data.

The processor 9010 may be configured to store, read, load, execute and/or otherwise process instructions 9070 stored in a computer-readable storage medium 9060, 9080 and/or in the memory 9020 such that, when the instructions are executed by the processor, causes the apparatus 9000 to perform one or more or all steps of a method described herein for the concerned apparatus 9000.

The instructions may correspond to program instructions or computer program code. The instructions may include one or more code segments. A code segment may represent a procedure, function, subprogram, program, routine, subroutine, module, software package, class, or any combination of instructions, data structures or program statements. A code segment may be coupled to another code segment or a hardware circuit by passing and/or receiving information, data, arguments, parameters or memory contents. Information, arguments, parameters, data, etc. may be passed, forwarded, or transmitted via any suitable technique including memory sharing, message passing, token passing, network transmission, etc.

When provided by a processor, the functions may be provided by a single dedicated processor, by a single shared processor, or by a plurality of individual processors, some of which may be shared. The term “processor” should not be construed to refer exclusively to hardware capable of executing software and may implicitly include one or more processing circuits, whether programmable or not. A processor or likewise a processing circuit may correspond to a digital signal processor (DSP), a network processor, an application specific integrated circuit (ASIC), a field programmable gate array (FPGA), a System-on-Chips (SoC), a Central Processing Unit (CPU), an arithmetic logic unit (ALU), a programmable logic unit (PLU), a processing core, a programmable logic, a microprocessor, a controller, a microcontroller, a microcomputer, a quantum processor, any device capable of responding to and/or executing instructions in a defined manner and/or according to a defined logic. Other hardware, conventional or custom, may also be included. A processor or processing circuit may be configured to execute instructions adapted for causing the host device or host system to perform one or more functions disclosed herein for the host device or host system.

A computer readable medium or computer readable storage medium may be any tangible storage medium suitable for storing instructions readable by a computer or a processor. A computer readable medium may be more generally any storage medium capable of storing and/or containing and/or carrying instructions and/or data. The computer readable medium may be a non-transitory computer readable medium. The term “non-transitory”, as used herein, is a limitation of the medium itself (i.e., tangible, not a signal) as opposed to a limitation on data storage persistency (e.g., RAM vs. ROM).

A computer-readable medium may be a portable or fixed storage medium. A computer readable medium may include one or more storage device like a permanent mass storage device, magnetic storage medium, optical storage medium, digital storage disc (CD-ROM, DVD, Blue Ray, etc), USB key or dongle or peripheral, a memory suitable for storing instructions readable by a computer or a processor.

A memory suitable for storing instructions readable by a computer or a processor may be for example: read only memory (ROM), a permanent mass storage device such as a disk drive, a hard disk drive (HDD), a solid state drive (SSD), a memory card, a core memory, a flash memory, or any combination thereof.

In the present description, the wording “means configured to perform one or more functions” or “means for performing one or more functions” may correspond to one or more functional blocks comprising circuitry that is adapted for performing or configured to perform the concerned function(s). The block may perform itself this function or may cooperate and/or communicate with other one or more blocks to perform this function. The “means” may correspond to or be implemented as “one or more modules”, “one or more devices”, “one or more units”, etc. The means may include at least one processor and at least one memory including computer program code, wherein the at least one memory and the computer program code are configured to, with the at least one processor, cause an apparatus or system to perform the concerned function(s).

As used in this application, the term “circuitry” may refer to one or more or all of the following:
(a) hardware-only circuit implementations (such as implementations in only analog and/or digital circuitry) and
(b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions); and
(c) hardware circuit(s) and or processor(s), such as a microprocessor(s) or a portion of a microprocessor(s), that requires software (e.g., firmware) for operation, but the software may not be present when it is not needed for operation.”

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, an integrated circuit for a network element or network node or any other computing device or network device.

The term circuitry may cover digital signal processor (DSP) hardware, network processor, application specific integrated circuit (ASIC), field programmable gate array (FPGA), etc. The circuitry may be or include, for example, hardware, programmable logic, a programmable processor that executes software or firmware, and/or any combination thereof (e.g. a processor, control unit/entity, controller) to execute instructions or software and control transmission and receptions of signals, and a memory to store data and/or instructions.

The circuitry may also make decisions or determinations, generate frames, packets or messages for transmission, decode received frames or messages for further processing, and other tasks or functions described herein. The circuitry may control transmission of signals or messages over a radio network, and may control the reception of signals or messages, etc., via one or more communication networks.

Although the terms first, second, etc. may be used herein to describe various elements, these elements should not be limited by these terms. These terms are only used to distinguish one element from another. For example, a first element could be termed a second element, and similarly, a second element could be termed a first element, without departing from the scope of this disclosure. As used herein, the term “and/or,” includes any and all combinations of one or more of the associated listed items.

The terminology used herein is for the purpose of describing particular embodiments only and is not intended to be limiting. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

While aspects of the present disclosure have been particularly shown and described with reference to the embodiments above, it will be understood by those skilled in the art that various additional embodiments may be contemplated by the modification of the disclosed machines, systems and methods without departing from the scope of what is disclosed. Such embodiments should be understood to fall within the scope of the present disclosure as determined based upon the claims and any equivalents thereof.

### LIST OF MAIN ABBREVIATIONS

BER Bit Error Rate
CNN Convolutional Neural network
DeepRx Deep Learning Receiver
DL Deep Learning
DLNN Deep Learning Neural network
FLOPS Floating Point Operations
LMMSE Linear Minimum Mean Square Error
MIMO Multiple Input Multiple Output
MRC Maximal Ratio Combining
NN Neural network
QAM Quadrature Amplitude Modulation
QPSK Quadrature Phase Shift Keying
RX Receiver
SIMO Single Input Multiple Output
SISO Single Input Single Output
SNR Signal Noise Ratio
TOPS Tera operations

1. A method for use by a radio receiver, the method comprising:
receiving a modulated radio signal including input bits, wherein the input bits are modulated in the input radio signal according to a modulation scheme in a plurality of modulation schemes supported by the radio receiver;
configuring the radio receiver with a postprocessing function selected based on the modulation scheme among a plurality of postprocessing functions supported by the radio receiver, wherein each of the plurality of postprocessing functions is based on a postprocessing neural network, NN, and is trained for postprocessing of a signal modulated according to a respective modulation scheme in the plurality of modulation schemes, wherein the selected postprocessing function is trained for postprocessing of a signal modulated according to said modulation scheme;
generating probability information for the input bits, wherein generating the probability information includes
generating an intermediate signal from at least the modulated radio signal;
performing postprocessing on the intermediate signal to generate the probability information using the selected postprocessing function.

2. The method of claim 1, wherein generating the intermediate signal includes:
performing preprocessing based on reference signals using a preprocessing function based on a preprocessing NN common to the plurality of modulation schemes to generate a preprocessed signal;
performing signal processing on the preprocessed signal and the modulated radio signal to generate the intermediate signal.

3. The method of claim 2, wherein the signal processing includes equalization.

4. The method of claim 1, comprising
obtaining information indicative of the modulation scheme, the information including a modulation type and a modulation order, wherein the selecting is performed based on at least one of the modulation type and the modulation order.

5. The method of claim 1, wherein
wherein the plurality of postprocessing functions includes a first postprocessing function that is based on a first postprocessing NN and is adapted for postprocessing of a signal modulated according to a first modulation scheme having a first modulation type and a first modulation order,
wherein the plurality of postprocessing functions includes a second postprocessing function that is based on a second postprocessing NN and is adapted for postprocessing of a signal modulated according to the first modulation scheme having the first modulation type and a second modulation order smaller than the first modulation order,
wherein the second postprocessing function uses less computation resources than the first postprocessing function.

6. The method of claim 5, wherein the second postprocessing NN has a reduced model size compared to the first postprocessing NN.

7. The method of claim 5,
wherein the first postprocessing NN includes a plurality of computation functions including convolutional layers, each convolutional layer using convolutional filters and generating corresponding output channels;
wherein the second postprocessing NN corresponds to a subpart of the plurality of convolution filters and corresponding output channels of at least one convolutional layer of the first postprocessing NN,
wherein, when the selected postprocessing function is the second postprocessing function, the computation functions of the first postprocessing NN that are not in said subpart are deactivated.

8. The method of claim 1, comprising
training simultaneously the preprocessing NN and a first postprocessing NN associated with a first modulation scheme having the highest modulation order;
training each postprocessing NN associated with another modulation scheme having a lower modulation order than the first modulation scheme by using the trained preprocessing NN.

9. The method of claim 8, wherein training the postprocessing NN associated with the another modulation scheme includes:
reducing the size of the first postprocessing NN associated with the first modulation scheme to generate a reduced postprocessing NN;
training the reduced postprocessing NN by using the trained preprocessing NN;
computing a performance indicator for the reduced postprocessing NN;
repeating the reducing, training and computing steps for the reduced postprocessing NN until a performance decrease criterion is met for the performance indicator;
using the last reduced postprocessing NN as the postprocessing NN associated with the second modulation scheme.

10. The method of claim 9, wherein reducing the size of the concerned NN includes at least one of:
reducing the number of convolutional layers of the concerned NN;
reducing the number of convolutional filters of the concerned NN.

11. The method of claim 1, comprising
training simultaneously the preprocessing NN and the postprocessing NNs.

12. An apparatus comprising means for performing a method comprising:
receiving a modulated radio signal including input bits, wherein the input bits are modulated in the input radio signal according to a modulation scheme in a plurality of modulation schemes supported by the radio receiver;
configuring the radio receiver with a postprocessing function selected based on the modulation scheme among a plurality of postprocessing functions supported by the radio receiver, wherein each of the plurality of postprocessing functions is based on a postprocessing neural network, NN, and is trained for postprocessing of a signal modulated according to a respective modulation scheme in the plurality of modulation schemes, wherein the selected postprocessing function is trained for postprocessing of a signal modulated according to said modulation scheme;
generating probability information for the input bits, wherein generating the probability information includes
generating an intermediate signal from at least the modulated radio signal;
performing postprocessing on the intermediate signal to generate the probability information using the selected postprocessing function.

13. An apparatus according to claim 12, wherein the means comprise
at least one processor;
at least one memory storing instructions that, when executed by the at least one processor, cause the apparatus to perform the method.

14. (canceled)

15. A non-transitory computer-readable medium comprising program instructions stored thereon for causing an apparatus to perform:
receiving a modulated radio signal including input bits, wherein the input bits are modulated in the input radio signal according to a modulation scheme in a plurality of modulation schemes supported by the radio receiver;
configuring the radio receiver with a postprocessing function selected based on the modulation scheme among a plurality of postprocessing functions supported by the radio receiver, wherein each of the plurality of postprocessing functions is based on a postprocessing neural network, NN, and is trained for postprocessing of a signal modulated according to a respective modulation scheme in the plurality of modulation schemes, wherein the selected postprocessing function is trained for postprocessing of a signal modulated according to said modulation scheme;
generating probability information for the input bits, wherein generating the probability information includes
generating an intermediate signal from at least the modulated radio signal;
performing postprocessing on the intermediate signal to generate the probability information using the selected postprocessing function.
